(19) United States
(12) Patent Application Publication
(10) Pub. No.: US 2021/0192011 A1
(43) Pub. Date: Jun. 24, 2021

(54) DATA TRANSMISSION APPARATUS, METHOD OF CONTROLLING DATA TRANSMISSION APPARATUS, AND STORAGE MEDIUM

(71) Applicant: CANON KABUSHIKI KAISHA, Tokyo (JP)

(72) Inventor: Ryosuke Kasahara, Ibaraki (JP)

(21) Appl. No.: 17/113,739

(22) Filed: Dec. 7, 2020

(30) Foreign Application Priority Data
Dec. 18, 2019 (JP) 2019-228217

(51) Int. Cl. G06F 21/10; G06K 9/00; G06K 9/78

(52) U.S. Cl. CPC G06F 21/10; G06K 9/00442; G06F 3/0482; G06K 2209/01; G06K 9/78

(57) ABSTRACT

A data transmission apparatus includes a setting unit configured to set a plurality of settings for restricting execution of transmission processing causing the data transmission apparatus to transmit data to an area outside a predetermined area. The setting unit sets the plurality of settings based on a simple operation executed by a user.

### BACKGROUND

### Field of the Disclosure

The present disclosure relates to data transmission apparatuses, method of controlling a data transmission apparatus, and storage media.

### Description of the Related Art

There have been provided data transmission devices for transmitting data.

Japanese Patent Application Laid-Open No. 2010-183340 discusses a technique which enables a data transmission device to determine whether country information included in its own network address conforms to the country information on a phone number of a data transmission destination or not, and, if not, to restrict data transmission.

In a specific area made up of a plurality of countries, transmitting data (particularly, data including personal information) from the area to the outside of that area may be a breach of rules and regulations.

Although a user can change relevant settings of the data transmission device in order to follow rules and regulations, operation of the user can be burdensome with many settings to be set.

### SUMMARY

In light of the above-described issue, embodiments of the present disclosure are directed to providing a technique which enables a user to set settings following rules and regulations through a simple operation.

According to embodiments of the present disclosure, a data transmission apparatus includes a setting unit configured to set a plurality of settings for restricting execution of transmission processing causing the data transmission apparatus to transmit data to an area outside a predetermined area. The setting unit sets the plurality of settings based on a single operation executed by a user.

Further features of the present disclosure will become apparent from the following description of exemplary embodiments with reference to the attached drawings.

### BRIEF DESCRIPTION OF THE DRAWINGS

FIG. 1 is a block diagram illustrating a network configuration according to a first exemplary embodiment.

FIG. 2 is a block diagram illustrating the hardware configuration of a data transmission device according to the first exemplary embodiment.

FIG. 3 is a diagram illustrating country setting screens and a country setting of the data transmission device according to the first exemplary embodiment.

FIG. 4 is a flowchart illustrating file transmission processing executed by the data transmission device according to the first exemplary embodiment.

FIG. 5 is a flowchart illustrating country information determination processing in data transmission executed by the data transmission device according to the present exemplary embodiment.

FIG. 6 is a flowchart illustrating transmission prohibition processing in data transmission executed by the data transmission device according to the first exemplary embodiment.

FIGS. 7A and 7B are a screen flow diagram of operation screens of the data transmission device according to the first exemplary embodiment.

FIG. 8 is a screen flow diagram of error screens in data transmission executed by the data transmission device according to the first exemplary embodiment.

FIG. 9 is a settings screen illustrating certification verification settings and transmission prohibition control settings of the data transmission device according to the first exemplary embodiment.

FIG. 10 is a flowchart illustrating transmission prohibition processing in data transmission executed by the data transmission device according to a second exemplary embodiment.

FIG. 11 is a flowchart illustrating an example of personal information protection setting processing according to a third exemplary embodiment.

FIG. 12 illustrates an example of a settings screen according to the third exemplary embodiment.

FIG. 13 illustrates an example of a settings screen according to the third exemplary embodiment.

### DESCRIPTION OF THE EMBODIMENTS

Exemplary embodiments according to the present disclosure will be described with reference to the appended drawings. However, the embodiments described below are not intended to limit the scope of the patent claims, and not all of the combinations of features described in the exemplary embodiments are necessarily included in the solutions of the present disclosure.

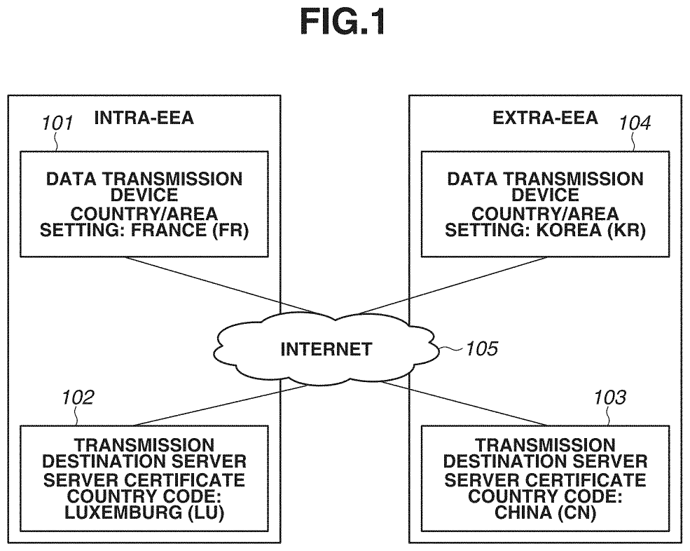

FIG. 1 is a block diagram illustrating a network configuration according to a first exemplary embodiment of the present disclosure. In the present exemplary embodiment, data transmission devices 101 and 104 as examples of data transmission devices and transmission destination servers 102 and 103 as examples of transmission destinations are communicably connected to one another via the internet 105.

In the present exemplary embodiment, each of the data transmission devices 101 and 104 is included in a multifunction peripheral (MFP) which transmits data such as image data to the transmission destination server 102 or 103.

Each of the transmission destination servers 102 and 103 is a file server which receives a file and stores the file in a folder thereof. Alternatively, each of the transmission destination servers 102 and 103 may be a mail server which receives and transfers electronic mails (e-mails). Further, each of the transmission destination servers 102 and 103 may he a web server which receives data through the Hyper-Text Transfer Protocol (HTTP). Additionally, each of the transmission destination server 102 and 103 may be a server having a plurality of functions of the above-described servers.

The data transmission device 101 and the transmission destination server 102 are installed in the European Economic Area (intra-EEA). The data transmission device 101 is installed in France, whereas the transmission destination server 102 is installed in Luxemburg. The data transmission device 104 and the transmission destination server 103 are installed in areas outside the EEA (extra-EEA). The data transmission device 104 is installed in Korea. These installation areas are merely examples, which can be changed. The transmission destination server 103 is installed in China. In principle, transmission of personal information (e.g., a name and an e-mail address) from an area in the EEA (intra-EEA) to an area in the extra-EEA is prohibited based on the General Data Protection Regulation (GDPR) in order to protect the personal information.

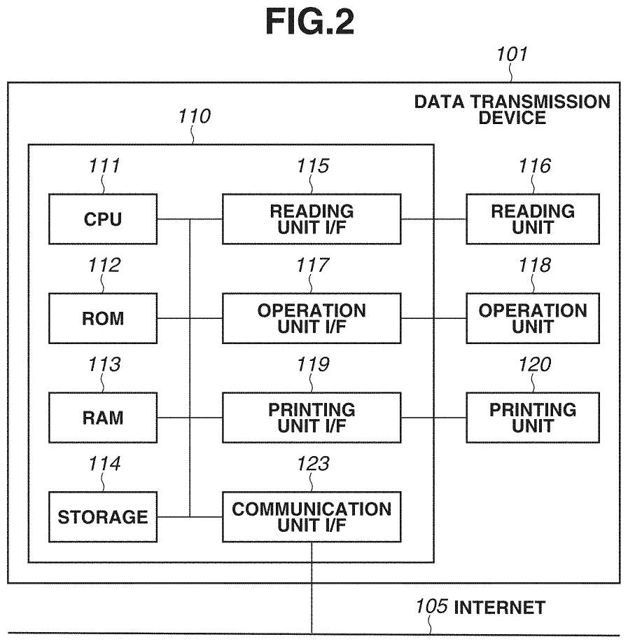

FIG. 2 is a block diagram illustrating a configuration of the data transmission device 101. The data transmission device 104 also has a similar configuration.

A control unit 110 that includes a central processing unit (CPU) 111 controls general operations of the data transmission device 101. The CPU 111 reads a control program stored in a read only memory (ROM) 112 or a storage 114 to execute various types of control such as reading control and printing control. The ROM 112 stores a control program executable by the CPU 111. The ROM 112 also stores a boot program and font data. A random access memory (RAM) 113 is a main memory of the CPU 111, and used as a work area or a temporary storage area for loading various control programs stored in the ROM 112 and the storage 114. The storage 114 stores image data, print data, an address book, various programs, and various types of setting information. The storage 114 is assumed to be a non-volatile flash memory in which the contents are not lost when the power to the memory is turned off and on. Alternatively, other storage media such as a solid state drive (SSD), a hard disk drive (HDD), or an embedded multimedia card (eMMC) may be used as an auxiliary storage device.

In the data transmission device 101, a single CPU 111 uses a single memory (i.e., RAM 113) to execute various types of processing illustrated in the flowcharts that will be described, but, the present exemplary embodiment may employ other methods. For example, the various types of processing illustrated in the flowcharts that will be described can be cooperatively executed by a plurality of CPUs, RAMs, ROMs, and storages. Further, partial processing may be executed on a hardware circuit such as an application specific integrated circuit (ASIC) or a field-programmable gate array (FPGA).

A reading unit interface (I/F) 115 connects a reading unit 116 to the control unit 110. For example, the reading unit 116 is a scanner which reads the image on a document to convert the image into binary image data. The image data generated by the reading unit 116 is transmitted to an external device, saved in an external storage device, or printed on a recording sheet.

An operation unit I/F 117 connects an operation unit 118 to the control unit 110. The operation unit 118 includes a display to display various types of information. In addition, the operation unit 118 accepts an input or an operation by a user via a touch panel sheet attached over the display or hard keys. The operation unit 118 can also ring a buzzer (not illustrated) for the user.

A printing unit I/F 119 connects a printing unit 120 to the control unit 110. The CPU 111 transfers image data to be printed (i.e., image data subject to print) to the printing unit 120 via the printing unit I/F 119. The printing unit 120 prints an image on a recording sheet fed from a sheet feeding cassette (not illustrated).

A communication unit I/F 123 connects the control unit 110 to the internet 105 in wired connection. The internet 105 may be connected in wireless communication, or replaced with a local area network (LAN). The communication unit I/F 123 can transmit image data to a file server or to an online storage, or an e-mail to a mail server. Further, the communication unit I/F 123 receives a request to refer to or change various types of setting information on the interior of the data transmission device 101 from an external personal computer (PC) connected to the internet 105, and reads out or changes various types of setting information stored in the storage 114. Image data is transmitted in a file by using a protocol such as the File Transfer Protocol (FTP), the Server Message Block (SMB), the Web-based. Distributed Authorizing and Versioning (WebDAV), the Simple Mail Transfer Protocol (SMTP), the Hyper-Text Transfer Protocol (HTTP), or the Session Initiation Protocol (SIP). Further, a web server application that uses HTTP also transmits and receives various types of setting information to and from a PC via the communication unit I/F 123. The web server application is stored in the ROM 112 and loaded on a memory in the RAM 113 after being started. The CPU 111 reads the web server application from the RAM 113 and runs the web server application to execute HTTP connection control via the communication unit I/F 123.

Now, an example will be described in which the data transmission device 101 according to the present exemplary embodiment, having the above-described configuration, determines whether a transmission destination of image data is included in a specific area which includes the country where the data transmission device 101 is installed, and then changes control processing for transmitting data.

In order to execute the above-described control, the user specifies settings of the country where the data transmission device 101 is installed, settings for personal information protection, and settings for checking a server certificate.

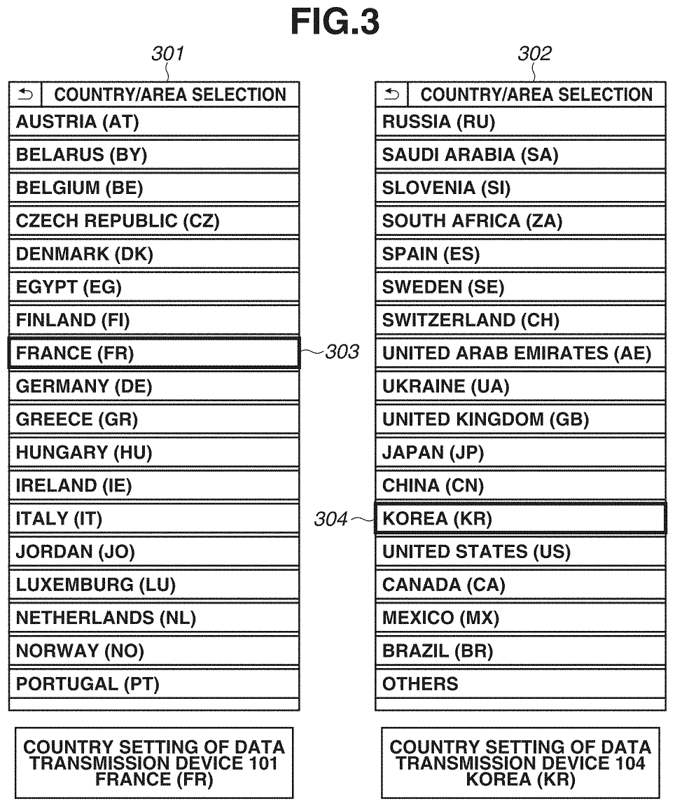

A screen 301 in FIG. 3 is an example of a screen for setting information about the country where the data transmission device 101 is installed. A screen 302 in FIG. 3 is an example of a screen for setting information about the country where the data transmission device 104 is installed.

As illustrated in FIG. 3, the user can set the country where the data transmission device 101 is installed on a country/area selection screen 301. The country/area selection screen 301 is a setting screen displayed on the operation unit 118 when the data transmission device 101 is first started or when the user presses a menu 503 and then a country/area selection key, both of which will be described below. Two letters in parentheses behind a country name are a country name code defined in the ISO 3166-2. In the present exemplary embodiment, a case will he described where the data transmission device 101 is installed in France (FR). In the country/area selection screen 301, France (FR) 303 is selected. With the France (FR) 303 selected, a press of an OK key (not illustrated) causes the France (FR) 303 to be set as the information about the country where the data transmission device 101 is installed, the set country information being stored in the storage 114. In addition, the display of the country/area selection screen 301 can be scrolled with an up/down key (not illustrated) on the operation unit 118, so that countries which are not seen thereon can be displayed.

On the other hand, the user can set the country where the data transmission device 104 is installed on a country/area selection screen 302. The country/area selection screen 302 is a setting screen displayed on the operation unit 118 of the data transmission device 104 when the data transmission device 104 is first started or when the user presses a menu 503 and then a country/area selection key, both of which will be described below. Two letters in parentheses after a country name are a country name code defined in the ISO 3166-2. In the present exemplary embodiment, a case will be described where the data transmission device 104 is installed in Korea (KR). In the country/area selection screen 302, Korea (KR) 304 is selected. With the Korea (KR) 304 selected, a press of an OK key (not illustrated) causes the Korea (KR) 304 to be set as the information about the country where the data transmission device 104 is installed, the setting of the Korea (KR) 304 being stored in the storage 114. In addition, the display of the country/area selection screen 302 can be scrolled with an up/down key (not illustrated) on the operation unit 118, so that countries which are not seen thereon can he displayed.

Further, the data transmission device 101 stores a country information table (i.e., Table 1 described below) in the ROM 112 of the data transmission device 101. This country information table includes area information that describes countries corresponding to country settings or destinations, to which it is permitted for data such as personal information to be transmitted. The data transmission device 104 also stores area information similar to that of the data transmission device 101 in the ROM 112 of the data transmission device 104.

Country codes compliant with the GDPR, for example, AT to CH shown below, are set as pieces of area information on a destination EEA 1000. A country setting DE 1002 has -the same country codes, not destinations, as those of the destination EEA 1000, which is expressed as “EEA”, which is a country code of the destination EEA 1000. Further, the area information on a destination JAPAN 1003 has JP and the pieces of area information on the destination EEA 1000 and on a destination US 1001 collectively set therein. Furthermore, as illustrated in the area information on JP 1004 or FR 1005, a uniform resource locator (URL) which includes the country code of the area information may be set therein. With the JP 1004 or the FR 1005 set in, the data transmission device 101 downloads the country code corresponding to the area information from a specific data server.

TABLE 1
Country Information Table

| Destination/ | Area information (Countries to which |
|---|---|
| Country | it is permitted for personal |
| Settings | information to be transmitted.) |
| EEA 1000 | AT, BE, BG, HR, CY, CZ, DK, EE, FI, |
| | FR, DE, GR, HU, IE, IT, LV, LT, LU, |
| | MT, NL, PL, PT, RO, SK, SI, ES, SE, |
| | GB, IS, LI, NO, CH |
| US 1001 | BR, MX, CA, US |
| DE 1002 | “EEA” |
| JAPAN 1003 | JP, “EEA”, “US” |
| JP 1004 | http://xxx.xxx.xxx.xxx/japan_table.xml |
| FR 1005 | http://xxx.xxx.xxx.xxx/france_table.xml |

Further, the data transmission device 101 may determine a country as a data transmission destination by making an inquiry to a server prepared to determine the country to which it is permitted for data to be transmitted instead of the table. According to the present exemplary embodiment, even a country joining in or withdrawing from the EEA can be reflected in the area information, which is acquired from the URL of the JP 1004 or the FR 1005, or from a server that determines the country. Besides, whether the list of country codes has been changed or not may be regularly checked by the area information controlled together with the country information being referred to.

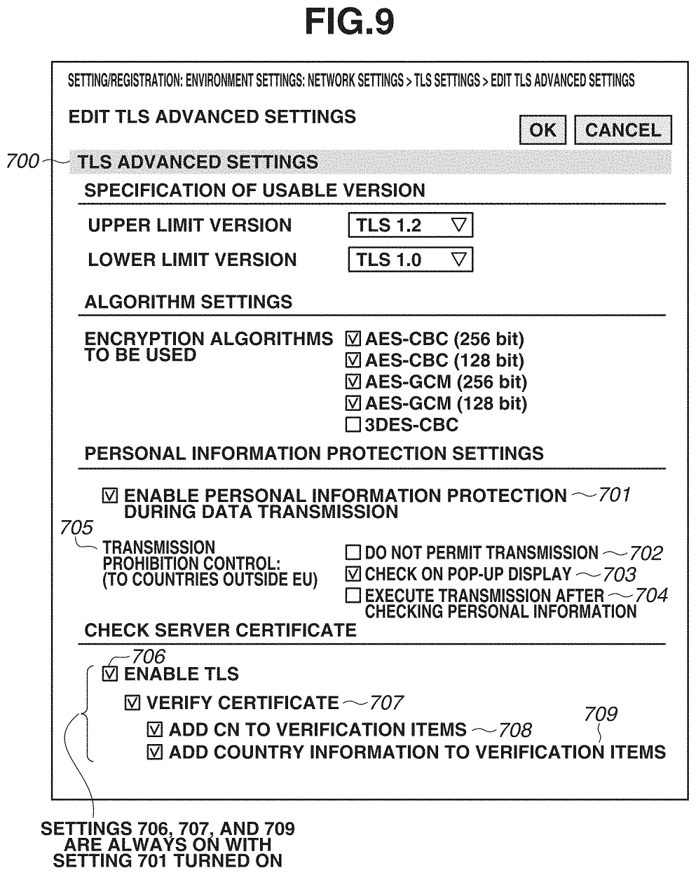

Next, settings that are set in advance will be described with reference to FIG. 9.

FIG. 9 is a transport layer security (TLS) advanced settings screen 700 displayed on a web browser of the external PC when an external PC accesses the data transmission device 101 using HTTP.

The data transmission device 101 can accept personal information protection settings and settings for checking a sere er certificate via the screen 700 in FIG. 9 according to the present exemplary embodiment.

As the personal information protection settings, a setting 701 for enabling personal information protection during data transmission and an item 705 for transmission prohibition control are displayed. The item 705 for transmission prohibition control includes a setting 702 for not permitting data transmission, a setting 703 for checking on a pop-up display, and a setting 704 for executing transmission after checking personal information, and the user can enable the settings by placing checkmarks in the checkboxes.

Enabling the setting 702 for not permitting data transmission prevents image data from being transmitted to any server installed in a country to which it is not permitted for image data to be transmitted.

Enabling the setting 703 for checking on a pop-up display makes it possible for the user to be alerted to the data transmission on a display of a message calling the user's attention when the user tries to transmit image data to a server installed in a country to which it is not permitted for image data to be transmitted.

With the selling 704 for executing transmission after checking personal information enabled, the data transmission device 101 determines whether personal information is included in the image data before transmitting image data. With the setting 704 for executing transmission after checking personal information not enabled, the data transmission device 101 displays a message calling the user's attention regardless of whether personal information is included in the image data. On the other hand, with the setting 704 for executing transmission after checking personal information enabled, the data transmission device 101 determines whether personal information is included in image data to be transmitted. Then, if the data transmission device 101 determines that personal information is included, a message calling the user's attention is displayed thereon; otherwise, transmission of image data is executed with the message calling the user's attention not displayed.

As the settings for checking a server certificate, a setting 706 for enabling TLS and a setting 707 for verifying a certificate are accepted. If the setting 701 for enabling personal information protection during data transmission is enabled, the setting 706 for enabling TLS may be set unchangeably at all times.

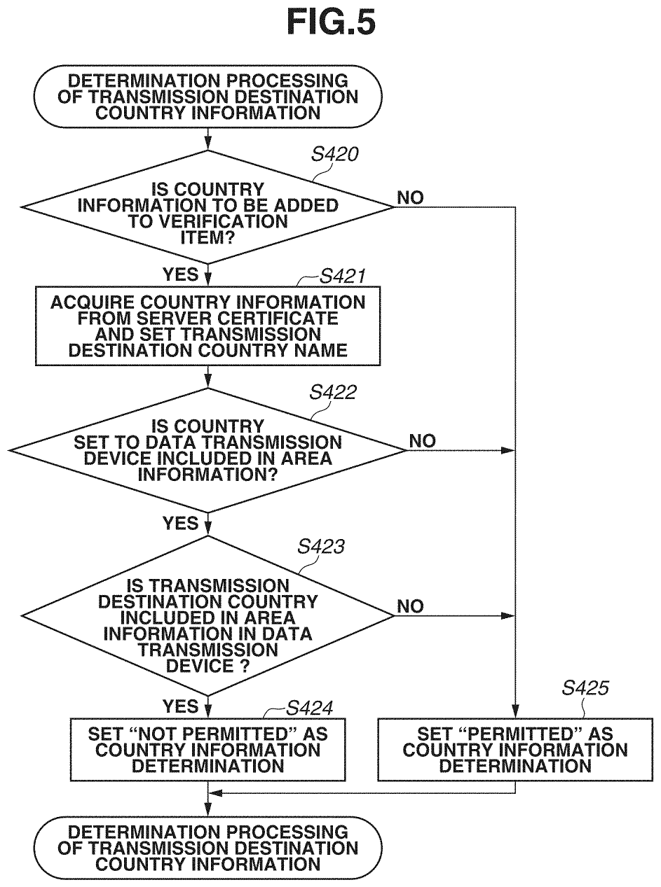

With the setting 707 for verifying a certificate enabled, a setting 708 for adding a common name (CN) to verification items and a setting 709 for adding country information to verification items can be accepted. Enabling the setting 709 for adding country information to the verification items makes it possible for country information determination processing illustrated in FIG. 5 to be executed.

The settings on the screen 700 in FIG. 9 are transmitted to the data transmission device 101 from the external PC and stored in the storage 114 of the data transmission device 101 to be thereafter referred to by the CPU 111.

In the present exemplary embodiment, an example is described of displaying the screen 700 in FIG. 9 on the web browser of the external PC. Additionally, the same screen as the screen 700 may be displayed on the operation unit 118 of the data transmission device 101. If the user makes settings by operating the screen 700 displayed on the operation unit 118 of the data transmission device 101, the settings are stored in the storage 114 of the data transmission device 101 to be referred to by the CPU 111 later.

The above description covers the settings made on the data transmission device 101 beforehand.

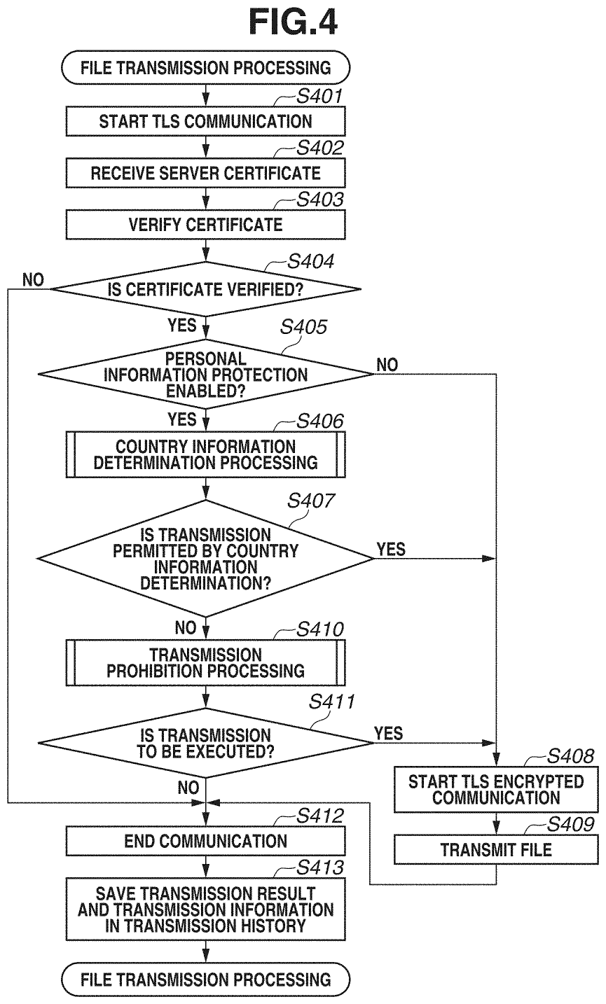

With the settings made above, the data transmission device 101 executes processing following flowcharts illustrated in FIGS. 4 to 6.

FIGS. 4 to 6 are flowcharts illustrating processing to be executed for the transmission of a file from the data transmission device 101 to the transmission destination server 102 or 103. The CPU 111 of the data transmission device 101 runs a program stored in the ROM 112 or the storage 114 to perform the processing illustrated in the flowcharts. When the data transmission device 104 transmits a file to the transmission destination server 102 or 103, the CPU 111 of the data transmission device 104 runs a program stored in the ROM 112 or the storage 114 to perform the corresponding processing illustrated in the flowcharts. Although the present exemplary embodiment is described based on the assumption that HTTP or SMTP is used in file transmission, a protocol allowing TLS communication that is used in executing data transmission is applicable, among various protocols. In the processing of the flowcharts described in the present disclosure, the CPU 111 of the data transmission device 101 controls the operation unit I/F 117 to execute display control of the operation unit 118, and detects a press on a screen via a touch sensor. Further, the CPU 111 controls the communication unit I/F 123 to perform network communications with an external communication device via the internet 105. The CPU 111 executes the above control by reading and writing the storage 114, the RAM 113, and the ROM 112.

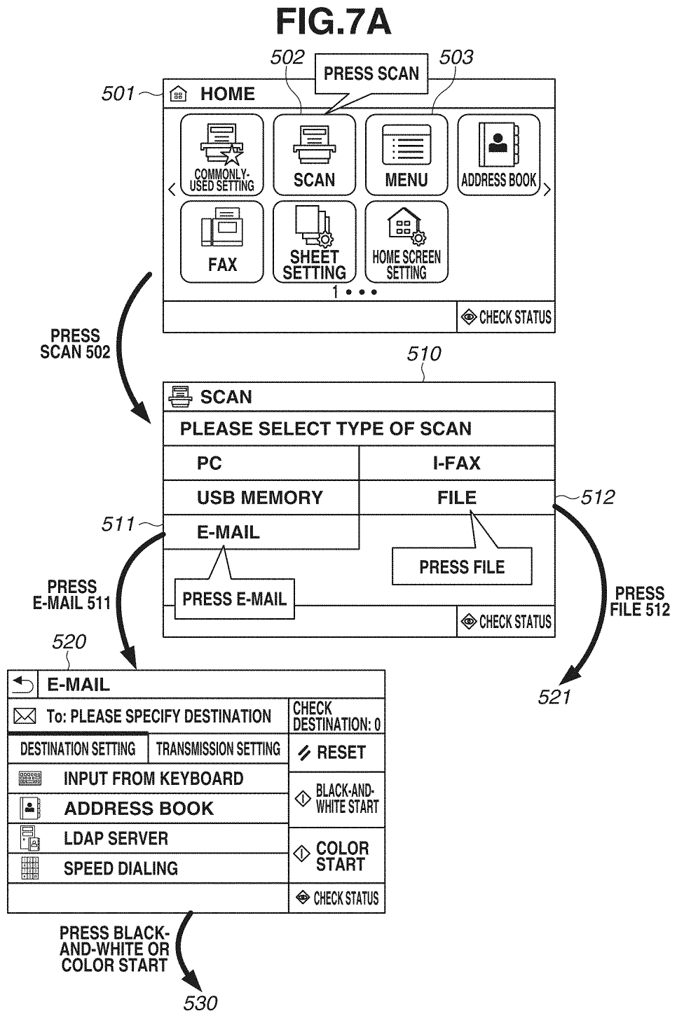

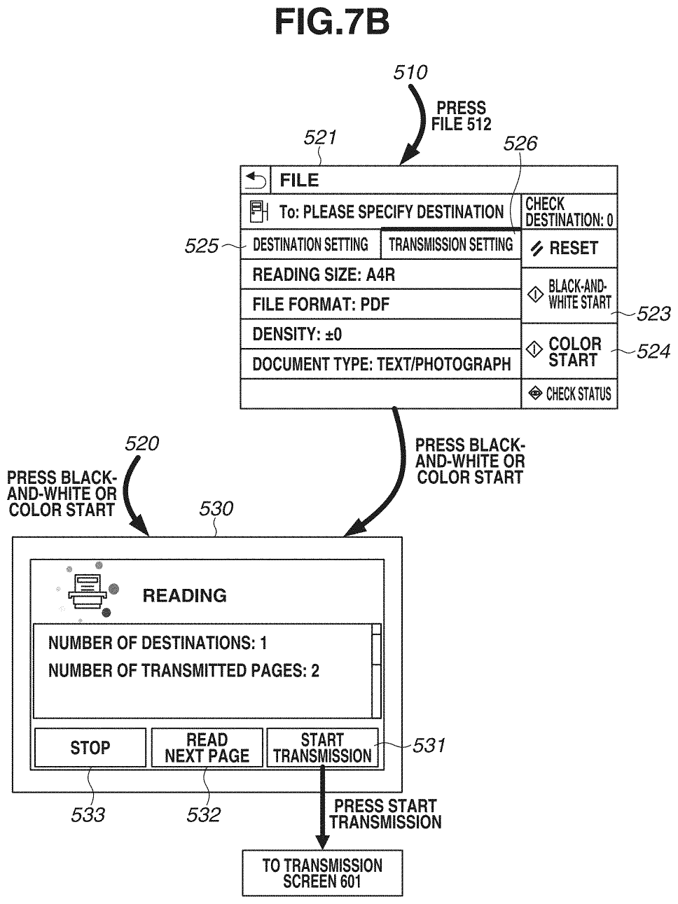

The processing in FIG. 4 is started in response to a transmission start key being pressed with a data transmission destination received via the operation unit 118. The transmission start key will be illustrated as a start transmission button 531 in FIG. 7B. In the present exemplary embodiment, an example will be described of a file transmission that transmits data in a file to a destination compliant with a file transmission protocol that is received, as a data transmission destination.

In step S401, the CPU 111 controls the communication unit I/F 123 to transmit “ClientHello” to the transmission destination server 103 via the interact 105 to start TLS communication. The data transmission device 101 receives “ServerHello” from the transmission destination server 103 and the processing proceeds to the next step.

In step S402, the CPU 111 receives a server certificate from the server 103 as the data transmission destination via the communication unit I/F 123. The server certificate describes an electronic signature, a CN (fully qualified domain name (FQDN)), an organization name, a country code (C), a validity period of the certificate, a serial number, and/or the reference source of an expired list.

In step S403, with the setting 707 for verifying a certificate enabled, the CPU 111 verifies whether the electronic signature is legitimate and the receipt time falls within the validity period to verify the received server certificate. Additionally, with the setting 708 for adding CN to the verification items enabled, the CN is compared with the FQDN of the transmission destination server 103. Whether the receipt time falls within the validity period is determined by whether the time information acquired from a timer (not illustrated) in the data transmission device 101 falls within the validity period of the server certificate.

In step S404, the CPU 111 determines whether the server certificate is verified in step S403. For example, if the electronic signature is legitimate, the receipt time falls within the validity period, and the CN matches the FQDN of the transmission destination server 103, the CPU 111 determines that the server certificate is verified. On the other hand, if the electronic signature is illegitimate, the receipt time falls outside the validity period, or the CN does not match the FQDN of the transmission destination server 103, the CPU 111 determines that the server certificate is not verified. The data transmission device 101 determines that the certificate is verified if no problem is found in the server certificate, and determines that the certificate is not verified if any problem is found in the server certificate. If the server certificate is verified (YES in step S404), the processing proceeds to step S405. If the server certificate is not verified (NO in step S404), the processing proceeds to step S412.

In step S405, with the setting 701 for personal information protection enabled (YES in step S405), the processing proceeds to step S406, and with the setting 701 disabled (NO in step S405), the processing proceeds to step S408. Alternatively, with an intra-EEA country set via the country/area selection screen 301 in FIG. 3, the setting 701 for enabling personal information protection may always be enabled, prevented from being changed or disabled. As a method to prevent the setting 701 from being changed to the disabled setting, the CPU 111 transmits to the external PC an HTML file that prevents a ticked checkbox of the setting 701 for enabling personal information protection from being unticked, such as making the checkbox grayed out.

In step S405, country information determination processing is executed that determines whether transmission is permitted to the transmission destination server based on the country code described in the server certificate. The country information determination processing will be described below with reference to the flowchart in FIG. 5.

In step S407, if the country information determination processing executed in step S406 determines that the transmission is permitted (YES in step S407), the processing proceeds to step S408; otherwise (NO in step S407), the processing proceeds to step S410.

In step S408, the CPU 111 controls the communication unit 123 to exchange a common key used in TLS encrypted communication and starts TLS encrypted communication.

In step S409, in response to the user's pressing the start transmission button 531 displayed on the reading screen 530, the CPU 111 causes the reading unit 116 to scan a document based on the transmission settings set to a transmission setting 526. Then, the CPU 111 converts the image data generated based on the scanned document into a file of a file format set via the transmission setting 526, and transmits the file to a destination specified via a destination setting 525.

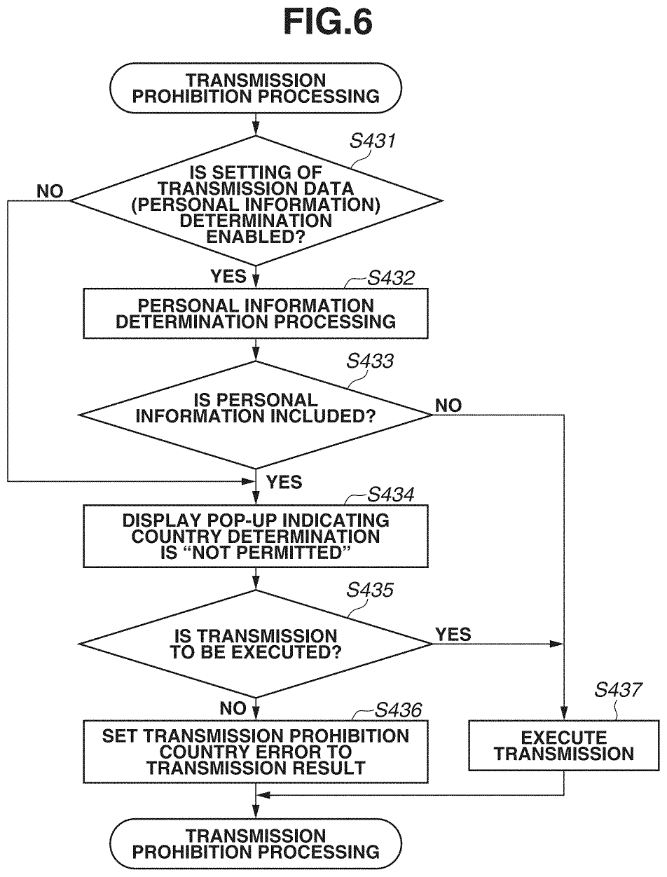

If the processing proceeds from step S407 to step S410, in step S410, the CPU 111 executes transmission prohibition control with the transmission not permitted through the country information determination processing. The transmission prohibition control will be described in detail with reference to FIG. 6.

In step S411, the CPU 111 determines whether to execute the transmission of the image data based on the result of the transmission prohibition control. If the transmission of the image data is to be executed in response to a determination by the CPU 111 (YES in step S411), the processing proceeds to step S408. If not (NO in step S411), the processing proceeds to step S412.

In step S412, the CPU 111 ends the session with the transmission destination server 103 and ends the file transmission.

In step S413, the CPU 111 saves information on the transmission of the image data such as a transmission result, a communication period, and the number of transmitted pages in the transmission history. The transmission destination server 103 as a transmission destination of the image data notifies the data transmission device 101 of the transmission result of the image data.

FIG. 5 is a flowchart illustrating the country information determination processing executed in step S406. In the flowchart of the transmission destination country determination processing, an example will he described of country settings of the data transmission device 101 installed in France (FR) in the intra-EEA and the data transmission device 104 installed in Korea (KR) in the extra-EEA. In addition, an example will be described of transmission destination country name settings of the transmission destination server 102 installed in Luxemburg (LU) in the intra-EEA and the transmission server 103 installed in China (CN) in the extra-EEA.

In step S420, the CPU 111 checks the setting 709 for adding country information to verification items. If the setting 709 is disabled (NO in step S420), the processing proceeds to step S425. If the setting 709 is enabled, the processing proceeds to step S421.

In step S421, the CPU 111 acquires a country code from the server certificate received from the server in step S402, and sets the transmission destination country name. If the transmission destination of data is the transmission destination server 103, “China (CN)” is set as the transmission destination country name. On the other hand, if the transmission destination of data is the transmission destination server 102, “Luxemburg (LU)” is set as the transmission destination country name. Similarly, the data transmission device 104 sets “China (CN)” as the transmission destination country name if the transmission destination is the transmission destination server 103, and sets “Luxemburg (LU)” as the transmission destination country name if the transmission destination is the transmission destination server 102.

In step S422, the CPU 111 determines whether “France (FR)” set with the country setting 303 of the data transmission device 101 is included in the area information for the destination/country setting of the table 1. As “France (FR)” is included in the area information on the EEA (YES in step S422), the processing proceeds to step S423.

In step S423, the CPU 111 determines whether the transmission destination country name set in step S421 is included in the area information on the area the same as that of the data transmission device 101, If the transmission destination country name is determined to be included in the same area information (YES in step S423), the processing proceeds to step S425. if the transmission destination country name is determined to not be included in the same area information (NO in step S423), the processing proceeds to step S424. For example, if the data, transmission device 101 is a transmission source of data, the processing proceeds to step S424 with the transmission destination server 103 as the data transmission destination, and the processing proceeds to step S425 with the transmission destination server 102 as the data transmission destination.

In step S424, the CPU 111 sets “NOT PERMITTED”, which means that data transmission is not permitted, as the country information determination.

In step S425, the CPU 111 sets “PERMITTED”, which means that data transmission is permitted, as the country information determination.

Through the processing illustrated in the flowchart of FIG. 5, the country information can be determined based on the country code of the server certificate and the country setting of the data, transmission device.

In addition, the present disclosure is applicable not only to data transmission devices installed in the intra-EEA and the extra-EEA countries, but also to any data transmission device which makes a determination on whether data transmission is permitted or prohibited depending on the area information, including a plurality of countries to which it is allowed for data to be transmitted, based on the country setting of the data transmission device.

FIG. 6 is a flowchart illustrating transmission prohibition processing executed in step S410.

In step S431, if the setting 704 for executing transmission after checking personal information is enabled (YES in step S431), the processing proceeds to step S432. If the setting 704 is disabled (NO in step S431), the processing proceeds to step S434.

In step S432, the CPU 111 executes processing for determining whether data to be transmitted includes personal information. The CPU 111 executes optical character recognition (OCR) processing to extract a character string from an image of the data to be transmitted, and determines whether information such as a personal name, an e-mail address, or an address is included in the image, and further determines whether an image such as a human face, a whole body, or a fingerprint is included in the image. The data transmission device 101 may transmit the data to an external server and receive a determination result from the server, instead of determining the image.

In step S433, if the CPU 111 determines that personal information is included in the data to be transmitted (YES in step S433), the processing proceeds to step S434. If the CPU 111 determines that personal information is not included in the data to be transmitted (NO in step S433), the processing proceeds to step S437.

In step S434, in order to inform the user that data will be transmitted to a country (i.e., the extra-EEA) that it is not permitted for data to be transmitted to, the CPU 111 displays a pop-up screen 602 on the operation unit 118 to let the user determine whether to continue the transmission processing. In the present exemplary embodiment, a message “Transmission of personal information to the transmission destination country is prohibited. Please check the transmission document. Do you want to continue data. transmission processing?” is displayed together with buttons “YES 603” and “NO 604”. Alternatively, if the data to be transmitted is determined to be personal information as a personal information determination result, the CPU 111 may display only an OK button (not illustrated) together with the message “Transmission of personal information to the transmission destination country is prohibited. Please check the transmission document.”, which prevents the transmission processing. In this case, the processing proceeds to step S436 in response to the OK button being pressed.

In step S435, in response to the user pressing the YES 603 on the pop-up screen 602 (YES in step S435), the CPU 111 determines that the transmission processing will he executed continuously, so that the processing proceeds to step S437. If the user presses the NO 604 (NO in step S435), the CPU 111 determines that the transmission processing is discontinued, so that the processing proceeds to step S436.

In step S436, the CPU 111 determines that the data transmission will not be executed and stores information about the determination in the RAM 113.

In step S437, the CPU 111 determines that the data transmission will be executed and stores information about the determination in the RAM 113.

For a result that the transmission is not permitted through the country information determination processing illustrated in the flowchart in FIG. 6 as described above, a message for checking whether to continue data transmission processing is displayed on the operation unit 118, so that the user can determine whether to continue data transmission processing.

As illustrated in the flowcharts in FIGS. 4 to 6, according to the present exemplary embodiment, by acquiring country information from a server certificate received from a transmission destination server, the data transmission device 101 determines whether data can be transmitted to the country where the transmission destination server is installed, and executes control processing for restricting data transmission.

Additionally, the data transmission device 101 can continuously execute transmission processing if personal information is not included in the data to be transmitted. Besides, with an aim of prohibiting leakage of any information to any server in the extra-EEA, only the processing in step S436 of the flowchart in FIG. 6 executed in step S410 of FIG. 4 allows prohibition of transmission to the transmission destination server determined to be a server in the extra-EEA at all times. By contrast, a means of permitting transmission may be provided with a transmission destination server to which personal information may be transmitted under contract, even in a country that it is not permitted for personal information to be transmitted to. This can be realized by registering in the storage 114 a transmission destination server or a domain name to which it is permitted to transmit personal information.

FIGS. 7A and 7B illustrate an example of a screen flow diagram of operation screens displayed on the operation unit 118 before file transmission or e-mail transmission is started. The CPU 111 of the data transmission device 101 controls the operation unit 118 via the operation unit I/F 117 to display these screens on the operation unit 118.

A home screen 501 is displayed when the data transmission device 101 is activated. A detection by the CPU 111 of a press of a scan button 502 on the home screen 501 causes a scanning screen 510 to be displayed on the operation unit 118.

For an e-mail transmission, a press of an e-mail button 511 causes an e-mail screen 520 to be displayed. For a file transmission, a press of a file button 512 triggers a file screen 521 to be displayed.

The e-mail screen 520 displays the destination setting 525 for specifying an e-mail address as a transmission destination and the transmission setting 526 for specifying transmission settings for reading a document image with the reading unit 116 to generate an image data. Similarly, the file screen 521 displays the destination setting 525 for specifying a destination of the transmission destination server as a transmission destination and the transmission setting 526 for specifying transmission settings for reading a document image with the reading unit 116 to generate an image data. In addition, a press of a black-and-white start button 523 or a color start button 524 on the e-mail screen 520 or the file screen 521 triggers a reading screen 530 to be displayed thereon.

The reading screen 530 displays a message “Reading”, which indicates reading is being executed, and information about read documents such as the number of destinations and the number of pages transmitted. While the reading screen 530 is being displayed, the data transmission device 101 reads documents through the reading unit 116 to generate image data, converts the image data into a file based on the transmission setting information, and saves the generated file in the RAM 113. In addition, the reading screen 530 also displays a stop button 533, a read next page button 532, and the start transmission button 531. A press of the stop button 533 stops reading and then the screen is returned to the home screen 501. A press of the read next page button 532 causes the next page of the document to be read. By the start transmission button 531 being pressed, the reading is ended, a converted file is transmitted to the destination set by the destination setting 525, and the screen is shifted to a transmitting screen 601.

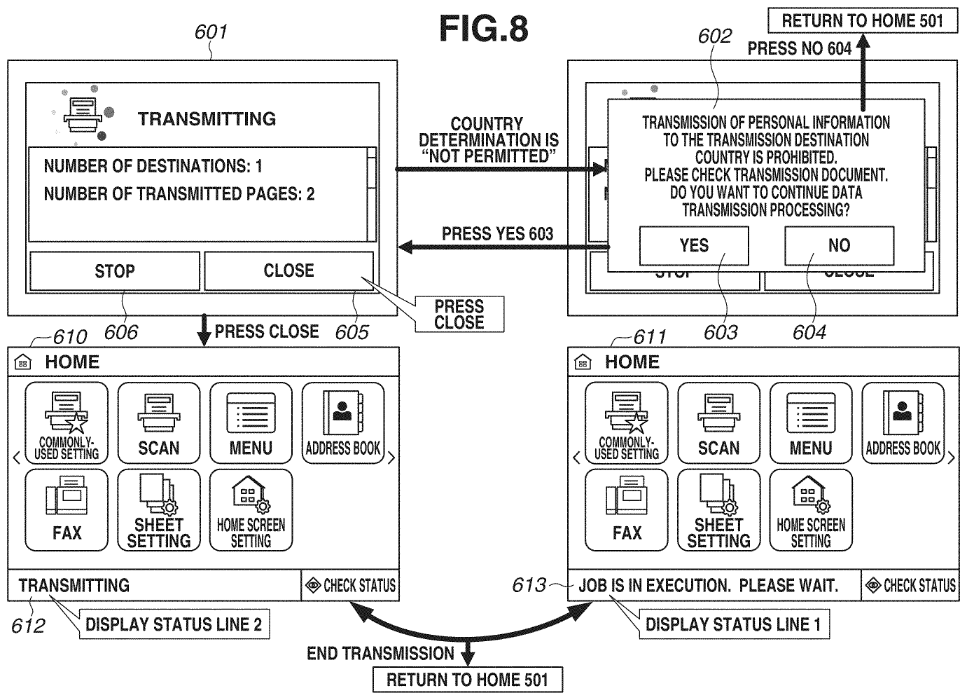

FIG. 8 is a screen flow diagram of screens to be displayed on the operation unit 118 after transmission of image data according to the present disclosure is started.

The transmitting screen 601 displays a message, “Transmitting”, which indicates transmission is being executed and transmission information such as the number of destinations and the number of pages transmitted. Additionally, the transmitting screen 601 displays two buttons, a stop 606 and a close 605. A press of the stop button 606 causes the CPU 111 to stop file transmission, delete a transmitted file, and end the file transmission. A press of the close button 605 causes the transmitting screen 601 to be closed, the screen being shifted to the home screen 610. In addition, the pop-up screen 602 is displayed in response to a result of the country determination in step S434 that the country is not permitted after the data transmission device 101 starts executing TLS communication on the transmitting screen 601. The data transmission processing is suspended unless a press of the YES button 603 or the NO button 604 on the pop-up screen 602 that is being displayed is detected. Besides, if a result of the country determination is that the country is not permitted after a press of the close button 605 is detected, the pop-up screen 602 is displayed while the home screen 610 or 611 is being displayed, the pop-up screen 602 shows the user a predetermined notification. Examples of the predetermined notification displayed on the pop-up screen 602 of FIG. 8 includes a notification indicating that transmission of personal information to the transmission destination country is prohibited, a notification prompting the user to check the document to be transmitted, and a notification prompting the user to select whether to execute transmission.

The home screen 611 is a home screen displayed while file transmission is being executed, and displays a status line 613 showing a message, for example, “Job is in execution. Please wait.”. The display of the home screen 610 is shifted to the home screen 611 in a predetermined time. The home screen 610 is a second home screen displayed while transmission is being executed, and displays a status line 612 showing a message “Transmitting”. The display of the status line 612 is changed to the status line 613 on the home screen 611 in a predetermined time while transmission is being executed. The display of the home screen 610 or 611 in the middle of transmission is returned to the home screen 501 with the status line 612 or 613 deleted upon transmission end.

As described above, an addition of an item for verifying the country information to the personal information protection settings and the settings for checking the server certificate allows the prohibition or restriction of data transmission from a specific area to an area that is not permitted for personal information to be transmitted to. Further, if the user of the data transmission device executes data transmission without being aware of the transmission destination, the pop-up screen 602 that appears on the operation unit 118 can prompt the user to check the data to be transmitted.

In the present exemplary embodiment, the example has been described that determines whether to display a predetermined notification screen for prompting the user to decide whether to execute the data transmission depending on whether the data transmission destination is in the intra-EEA or the extra-EEA. However, the present disclosure is not limited thereto. For example, countries, not limited to the EEA countries, may be registered as the areas to which it is permitted for data to be transmitted. With the registration, the above-described predetermined notification screen is displayed for data to be transmitted to a country outside the registered area whereas the notification screen is not displayed for data to be transmitted to a country in the registered area.

A second exemplary embodiment will be described. In the above-described first exemplary embodiment, the example has been described that determines whether to display the pop-up screen 602 in FIG. 8 or execute data transmission with the pop-up screen 602 not displayed depending on whether the data is to be transmitted to an area in the extra-EEA.

In the present exemplary embodiment, an example will be described that determine whether to execute data transmission depending on whether the data is to be transmitted to an area in the extra-EEA. A network configuration and a configuration of the data transmission device 101 are similar to those of the first exemplary embodiment, so that detailed descriptions thereof will be omitted.

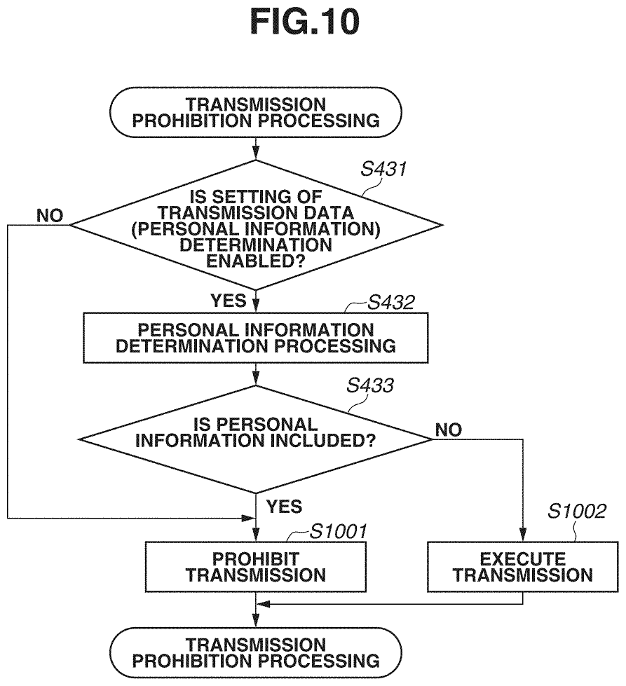

In the present exemplary embodiment, the processing illustrated in a flowchart in FIG. 10 is executed instead of the processing illustrated in the flowchart in FIG. 6 of the first exemplary embodiment.

The processing in steps S431 to S433 in FIG. 10 is similar to that of the first exemplary embodiment, so that description thereof will be omitted.

In step S1001, the CPU 111 shifts to a control mode for not continuing communication, and sets an error indicating a transmission prohibition country to a transmission result.

In step S1002, the CPU 111 shifts to a control mode for continuously executing transmission processing without setting a transmission error, and continues the file transmission.

Such processing allows the data transmission device 101 to determine whether to execute data transmission depending on whether data is to be transmitted to an area in the extra-EEA.

In the present exemplary embodiment, the data transmission device 101 determines whether to execute data transmission depending on whether the transmission destination of data is in the extra-EEA or the intra-EEA. However, the present disclosure is not limited thereto. For example, countries, not limited to the EEA countries, may be registered as the areas that it is permitted for data to be transmitted to, so that data transmission can be executed to a data transmission destination that is one of the registered areas, or data transmission cannot be executed to a data transmission destination that is a country outside the registered areas.

A third exemplary embodiment will be described. In the present exemplary embodiment, a method will be described of setting with a plurality of personal information protection functions with respect to the extra-EEA provided, in addition to whether to transmit personal information data to an area in the extra-EEA depending on the country setting of a data transmission device. A network configuration and a configuration of the data transmission device 101 are similar to those of the first exemplary embodiment, so that detailed descriptions thereof will be omitted.

Examples of above-described personal information protection functions with respect to the extra-EEA include a function of restricting import/export of address book data between devices and a function of setting a whitelist of transmission destinations which allows data to be transmitted to any of only the registered destinations. The restriction of export of address book data refers to the restriction of export of destination information such as a phone number or a folder path to an external device such as an external memory based on the country information set to the data transmission device representing an area within the intra-EEA. If the country information set to the data transmission device falls outside the intra-EEA, the device that exports destination information exports the destination information. On the other hand, the restriction of import of address book data refers to the restriction of receipt of destination information such as an e-mail address, a phone number, or a folder path stored in an address book from a device in the extra-EEA. Specifically, a device that exports destination information adds the country information set to the data transmission device to the destination information, and exports that destination information to an external device such as an external memory. Then, the device that imports the destination information compares the country information that is represented by the destination information imported from the external device such as an external memory with country information set to the data transmission device to determine whether to execute import. If the device that imports the destination information determines that import is to he executed, the device will import the destination information from the external device to a storage unit included in the device. If the device determines that import is not to be executed, the device will not import the destination information from the external device to the storage unit. For example, the device that imports the destination information prohibits execution of import if the country information that is represented by the destination information to be imported from the external device such as an external memory is country information that falls within the intra-EEA and the country information set to the device is country information that falls within the extra-EEA. The device that imports destination information may previously manage country information on intra-EEA countries in a table or other formats.

Specifically, in order for the user not to select an execution button to instruct import or export, a restriction method is to make the execution button grayed out or not displayed. Alternatively, even with a selectable execution button selected, the corresponding execution that is import or export of destination information may be disabled.

Further, examples of import includes forwarding destination information from an external storage unit such as a USB memory, as well as receiving from an external device. Examples of export includes forwarding destination information to an external storage unit such as a USB memory, as well as transmitting to an external device. The address book is stored in the storage 114 of the data transmission device 101.

In addition, the whitelist setting of transmission destinations is provided to prevent data from being transmitted to the destination corresponding to the destination information designated as information on a data transmission destination with the destination information not registered in the whitelist (address book) in advance. With the setting of a whitelist turned ON, the data transmission device 101 cannot transmit data to a destination corresponding to the destination information specified as information about the transmission destination of the data with that destination information not registered in the whitelist (address book) in advance. Specifically, for example, the CPU 111 determines whether destination information entered on the e-mail screen 520 via a keyboard is registered in the address book stored in the storage 114. The CPU 111 controls the data transmission device 101 not to transmit data to a destination corresponding to the destination information that is not registered. For example, the CPU 111 may disable selection of an execution button of the transmission processing, or may disable execution of the transmission processing even if the execution button is selected.

In the present exemplary embodiment, a setting method using a user mode will be described.

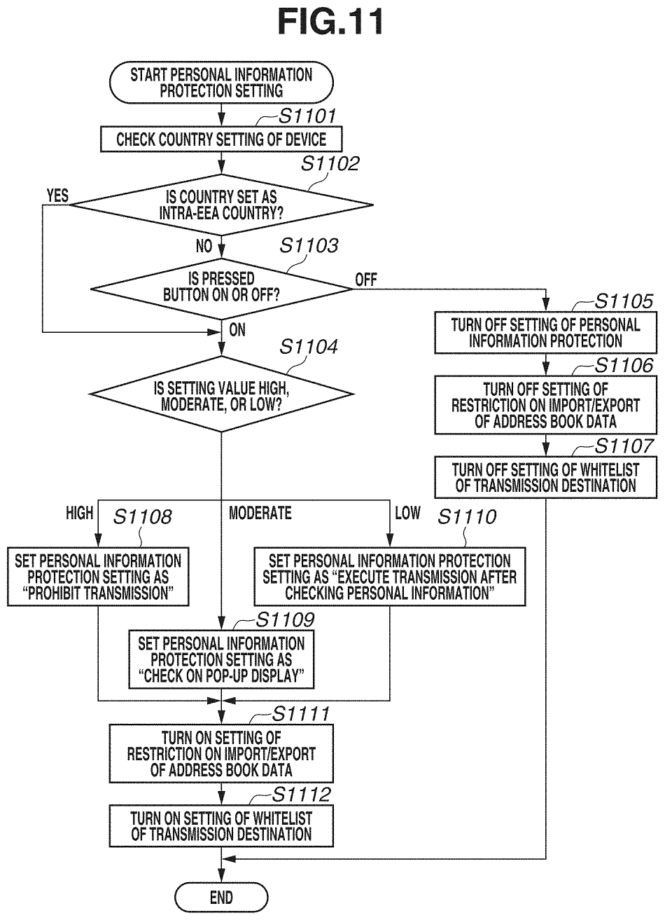

FIG. 11 is a flowchart illustrating an example of setting processing on personal information protection.

In step S1101, the CPU 111 checks the countries set to the data transmission device 101.

In step S1102, the CPU 111 refers to the country information table illustrated in the table 1 and determines whether the country is set as an intra-EEA country. If the country is an intra-EEA country (YES in step S1102), the CPU 111 will execute personal information protection setting. The CPU 111 advances the processing to step S1104 in order to make a setting for personal information protection. If the country is an extra-EEA country (NO in step S1102), the CPU 111 advances the processing to step S1103 in order to check whether to execute the personal information protection setting.

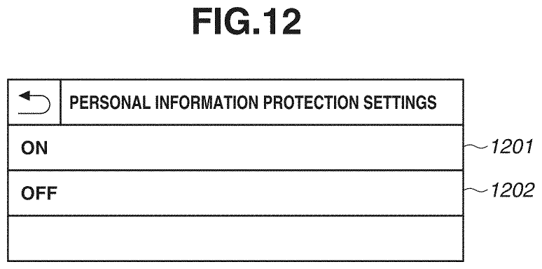

In step S1103, from a screen illustrated in FIG. 12, the CPU 111 determines whether the personal information protection setting is ON or OFF. If the user presses an ON button 1201 on the screen (“ON” in step S1103), the processing proceeds to step S1104. If the user presses an OFF button 1202 (“OFF” in step S1103), the processing proceeds to step S1105.

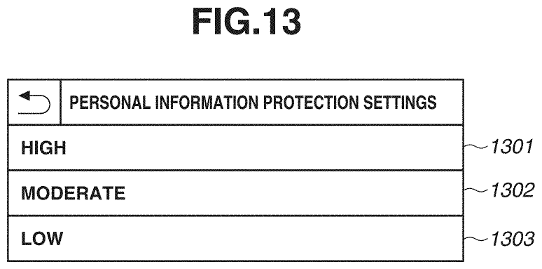

In step S1104, from a screen illustrated in FIG. 13, the CPU 111 determines the setting of the personal information protection. If the user presses a HIGH button 1301 on the screen (“HIGH” in step S1104), the processing proceeds to step S1108. If the user presses a MODERATE button 1302 (“MODERATE” in step S1104), the processing proceeds to step S1109. If the user presses a LOW button 1303 (“LOW” in step S1104), the processing proceeds to step S1110. This allows the user to change the setting for personal information protection, the setting of restriction on import/export of address book data, and the setting of the whitelist of transmission destinations through a single operation.

In the present exemplary embodiment, the screen of FIG. 13 is displayed by the ON button 1201 being selected on the screen of FIG. 12, so that the CPU 111 accepts a selection from the HIGH button 1301, the MODERATE button 1302, and the LOW button 1303. However, the present disclosure is not limited to the manner. For example, a selection of the ON button 1201 on the screen in FIG. 12 may allow setting a status identical to that of the enabled setting 702 for not permitting data transmission. This enables the user to change the personal information protection setting, the setting of restriction on import/export of address book data, and the setting of the whitelist of transmission destinations through a single operation with the screen of FIG. 13 not displayed.

In step S1105, the CPU 111 turns off the setting for personal information protection.

In step S1106, the CPU 111 turns off the setting of restriction on import/export of the address book data.

In step S1107, the CPU 111 turns off the setting of the whitelist of transmission destinations, and ends the processing.

In step S1108, the CPU 111 changes the personal information protection setting to “High”. Specifically, the CPU 111 changes the personal information protection setting to a setting similar to the setting where the setting 702 for not permitting transmission is enabled.

In step S1109, the CPU 111 changes the personal information protection setting to a setting similar to the setting where the setting 703 for checking on a pop-up display is enabled.

In step S1110, the CPU 111 changes the personal information protection setting to a setting similar to the setting where the setting 704 for executing transmission after checking personal information is enabled.

In step S1111, the CPU 111 turns on the setting of restriction on import/export of the address book data.

In step S1112, the CPU 111 turns on the setting of the whitelist of the transmission destinations, and ends the processing.

The execution of the above-described processing enables the user to specify a plurality of settings compliant with rules and regulations through a single operation. Further, the execution of the above-described processing enables the user to make a plurality of setting changes via a single button operation to comply with rules and regulations. Furthermore, the execution of the above-described processing enables the user to collectively set a plurality of settings following rules and regulations through a simple operation. Besides, the execution of the above-described processing enables the user to change a plurality of settings through a single type of operation to follow rules and regulations. Furthermore, the execution of the above-described processing enables the user to change a plurality of settings via a single operation on a single screen to follow rules and regulations.

In the present exemplary embodiment, the screen of FIG. 13 is displayed when the country is determined to be an intra-EEA country, and the plurality of settings is changed via a single operation executed by the user. Alternatively, if the country is determined to be an intra-EEA country, the plurality of settings may be changed automatically with no user operation accepted. In this case, the processing executed is similar to that executed with the HIGH button 1301 selected on the screen of FIG. 13.

The settings for personal information protection set through the flowchart in FIG. 11 are transmitted to the data transmission device 101 from the external PC, and stored in the storage 114 of the data transmission device 101, which are to be referred to by the CPU 111.

FIGS. 12 and 13 are diagrams each illustrating the example of a user mode screen. If the user selects the setting for personal information protection, the ON/OFF selection screen in FIG. 12 is displayed for a country in the extra-EEA. The setting for the function of personal information protection cannot be turned off for a country in the intra-EEA. Therefore the setting value screen in FIG. 13 is displayed thereon.

As described above, according to the present exemplary embodiment, the setting method of changing personal information protection settings via a single operation depending on the country settings of a device eliminates an insufficient setting change made by a user and a leakage of personal information data to the outside of a specific area.

Further, if another function relating to personal information protection is provided, the setting of that function may also be included in the above-described setting processing.

The present exemplary embodiment has been described with respect to the method which changes a range of personal information protection set depending on the area set in a device, but the present disclosure is not limited thereto. For example, if countries in the intra-EEA are selected on the country settings made at initial installation of a device, the processing according to the present exemplary embodiment may be executed after the country setting is completed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, tier example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-228217, filed Dec. 18, 2019, which is hereby incorporated by reference herein in its entirety.

What is claimed is:

1. A data transmission apparatus comprising:
a setting unit configured to set a plurality of settings for restricting execution of transmission processing causing the data transmission apparatus to transmit data to an area outside a predetermined area,
wherein the setting unit sets the plurality of settings based on a single operation executed by a user.

2. The data transmission apparatus according to claim 1, wherein the plurality of settings includes a first setting for setting whether to permit transmission processing causing the data transmission apparatus to transmit data determined to be personal information to an area outside the predetermined area.

3. The data transmission apparatus according to claim 2, wherein, with the first setting set so that execution of the transmission processing for transmitting the data determined to be personal information to an area outside the predetermined area is not permitted, the data transmission apparatus does not transmit the data determined to be personal information to the area outside the predetermined area.

4. The data transmission apparatus according to claim 3, wherein, with the first setting set so that execution of the transmission processing for transmitting the data determined to be personal information to an area outside the predetermined area is not permitted, the data transmission apparatus transmits the data determined to be personal information to an area inside the predetermined area.

5. The data transmission apparatus according to claim 2, wherein, with the first setting set so that execution of the transmission processing for transmitting the data determined to be personal information to an area outside the predetermined area is not permitted, the data transmission apparatus transmits data that is not determined to be personal information to an area outside the predetermined area.

6. The data transmission apparatus according to claim 2, further comprising:
a reading unit configured to read an image of a document to generate image data based on the image;
a character recognition unit configured to execute character recognition processing on the generated image data; and
a determination unit configured to determine whether the image data includes personal information based on a result of the character recognition processing.

7. The data transmission apparatus according to claim 2, further comprising a storage unit configured to store destination information,
wherein the plurality of settings includes a second setting for setting whether to permit execution of transmission processing for transmitting the destination information stored in the storage unit to an area outside the predetermined area.

8. The data transmission apparatus according to claim 2, further comprising an input unit configured to input destination information as information about a transmission destination of the data,
wherein the plurality of settings includes a third setting for setting whether to permit execution of transmission processing with a destination corresponding to the destination information input by the input unit as a transmission destination.

9. The data transmission apparatus according to claim 8, wherein the third setting is a setting for setting whether to permit transmission processing causing the data transmission apparatus to transmit the data to a destination corresponding to the destination information depending on whether the destination information input by the input unit has been registered in the data transmission apparatus.

10. The data transmission apparatus according to claim 1,
wherein, in a case where a country where the data transmission apparatus exists is inside the predetermined area, the setting unit sets the plurality of settings based on only a single operation executed by a user, and
wherein, in a case where a country where the data transmission apparatus exists is outside the predetermined area, the setting unit does not set the plurality of settings based on only a single operation executed by a user.

11. The data transmission apparatus according to claim 1, further comprising an acquisition unit configured to acquire information indicating a country where the data transmission apparatus exists from an external server.

12. The data transmission apparatus according to claim 1, further comprising a specification unit configured to specify the external server.

13. The data transmission apparatus according to claim 1, further comprising a changing unit configured to change information indicating a country where the data transmission apparatus exists.

14. The data transmission apparatus according to claim 1, wherein information indicating a country where an apparatus as a data transmission destination exists is included in a server certificate, the country being set by the setting unit.

15. The data transmission apparatus according to claim 1, wherein the predetermined area is a European Economic Area.

16. The data transmission apparatus according to claim 1, further comprising a printing unit.

17. A method of controlling a data transmission apparatus, the method comprising:
setting a plurality of settings for restricting execution of transmission processing causing the data transmission apparatus to transmit data to an area outside a predetermined area,
wherein the setting sets the plurality of settings based on a single operation executed by a user.

18. A non-transitory computer-readable storage medium storing a program that, when executed by a computer, causes the computer to perform a method of controlling a data transmission apparatus, the method comprising:
setting a plurality of settings for restricting execution of transmission processing causing the data transmission apparatus to transmit data to an area outside a predetermined area,
wherein the setting sets the plurality of settings based on a single operation executed by a user.
